(19) United States
(12) Patent Application Publication
(10) Pub. No.: US 2019/0100419 A1
(43) Pub. Date: Apr. 4, 2019

(54) ELEVATOR MACHINE LIFTING ASSEMBLY

(71) Applicants: THYSSENKRUPP ELEVATOR CORPORATION, Alpharetta, GA (US); THYSSENKRUPP AG, Essen (DE)

(72) Inventors: William E. Bowling, Palmetto, FL (US); Michael Bray, Elkhorn, NE (US); James Cherniss, Las Vegas, NV (US)

(21) Appl. No.: 15/723,853

(22) Filed: Oct. 3, 2017

(51) Int. Cl. B66F 7/12; B66F 7/28; B66B 19/00

(52) U.S. Cl. CPC B66F 7/12; B66B 19/005; B66F 7/28

(57) ABSTRACT

An elevator machine lifting assembly constructed in accordance to one example of the present disclosure includes a guide assembly, a frame assembly and a first jack assembly. The guide assembly include a guide base that supports the elevator machine and at least one roller. The frame assembly has a first vertical support member and a first baseplate. The first vertical support member provides a first track that receives the at least one roller thereon. The first jack assembly has a first lifting member that selectively moves relative to a first vertical column between a first position and a second position, the second position having a higher elevation than the first position. Movement of the lifting member from the first position to the second position causes the guide base and elevator machine to be raised relative to the frame assembly while the at least one roller rolls along the first track.

### FIELD

The present disclosure relates generally to elevator systems having at least one elevator car and more specifically to an elevator machine lifting assembly for lifting an elevator machine onto a motor plate on a machine stand assembly.

### BACKGROUND

Elevators are used in multi-floor buildings to transport passengers and goods to various floors throughout the building. Elevator cars are lifted between floors by an elevator machine. The elevator machine is typically mounted on a machine stand assembly located above a hoistway such as in an elevator room. Often the elevator machine is hoisted from above and mounted onto the machine stand during initial assembly of the elevator system, or during elevator machine replacement. In some instances however there may not be sufficient overhead space to properly locate such a lifting mechanism above the machine stand. It would be desirable to provide an apparatus for moving an elevator machine onto a machine stand in applications with low overhead operating conditions.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

An elevator machine lifting assembly constructed in accordance to one example of the present disclosure includes a guide assembly, a frame assembly and a first jack assembly. The guide assembly include a guide base that supports the elevator machine and at least one roller. The frame assembly has a first vertical support member and a first baseplate. The first vertical support member provides a first track that receives the at least one roller thereon. The first jack assembly has a first lifting member that selectively moves relative to a first vertical column between a first position and a second position, the second position having a higher elevation than the first position. Movement of the lifting member from the first position to the second position causes the guide base and elevator machine to be raised relative to the frame assembly while the at least one roller rolls along the first track.

According to additional features, the at least one roller comprises a first pair of rollers that are configured to roll along the first track. The rollers of the first pair of rollers roll along opposite surfaces of the first vertical support member. The frame assembly further comprises a first frame assembly, a second frame assembly and a connecting frame assembly. The first and second frame assemblies are positioned outboard of the elevator machine. The first frame assembly includes the first vertical support member and the first baseplate. The second frame assembly includes a second vertical support member and a second baseplate. The second vertical support member provides a second track. The guide assembly further comprises a first guide assembly having the first pair of rollers and a second guide assembly having a second pair of rollers. The rollers of the second pair of rollers roll along opposite surfaces of the second vertical support member. The first baseplate defines a notch that receives a portion of the jack assembly.

In additional features, the elevator machine lifting assembly further includes a cart having a cart body that includes a plurality of rigid protruding platform sections that collectively define a machine mounting platform. The cart includes guide rails that engage the guide base during movement of the lifting member from the first position to the second position. The cart is supported by a plurality of caster wheels. A second jack assembly has a second lifting member that selectively moves relative to a second vertical column between a first position and a second position. The first and second lifting members locate under the first and second baseplates.

A method of lifting an elevator machine from below with an elevator machine lifting assembly onto a motor plate of a machine stand assembly is provided. The elevator machine is positioned onto a cart of the machine lifting assembly. The cart and elevator machine are located adjacent to the machine stand assembly. First and second baseplates of a guide assembly are positioned under the cart. First and second vertical guide posts are located relative to a first and second pair of rollers extending from the guide assembly. First and second jack assemblies are positioned into engagement with the respective first and second baseplates. The first and second jack assemblies are actuated whereby first and second lifting members lift the first and second baseplates and therefore the elevator machine relative to the first and second vertical guide posts.

According to additional features, a first pair of rollers are rolled along the first vertical guide post. A second pair of rollers are rolled along the second vertical guide post. A first roller is rolled along a first surface of the first vertical guide post and a second roller is rolled along a second surface of the first vertical guide post. The first and second surfaces are oppositely facing. The first and second jack assemblies are actuated concurrently. A first support plate on the first jack assembly is located at least partially through a first notch defined in the first baseplate. A second support plate on the second jack assembly is located at least partially through a second notch defined in the second baseplate. The elevator machine is secured to the cart with fasteners. The cart is rolled along caster wheels extending from the cart.

### BRIEF DESCRIPTION OF THE DRAWINGS

The present disclosure will become more fully understood from the detailed description and the accompanying drawings, wherein:

FIG. 1 is a first perspective view of an elevator machine lifting assembly constructed in accordance to one example of the present disclosure and shown with an exemplary elevator machine and stand assembly;

FIG. 2 is a second perspective view of the elevator machine lifting assembly of FIG. 1 and shown with the exemplary elevator machine and stand assembly;

FIG. 3 is a front view of the elevator machine lifting assembly of FIG. 1 and shown with the exemplary elevator machine;

FIG. 4 is a perspective view of the elevator machine lifting assembly of FIG. 1, the elevator machine lifting assembly having a cart, a guide assembly, a frame assembly and a jack assembly;

FIG. 5 is a side view of the elevator machine lifting assembly shown positioned adjacent to the stand assembly;

FIG. 6 is a side view of the elevator machine lifting assembly shown positioned adjacent to the stand assembly and with the cart and guide assembly lifted relative to the frame assembly by the jack assembly to a first position;

FIG. 7 is a side view of the elevator machine lifting assembly shown positioned adjacent to the stand assembly and with the cart and guide assembly lifted relative to the frame assembly by the jack assembly to a second position where the elevator machine is generally on a common plane as a motor plate of the stand assembly;

FIG. 8 is a close-up view of a first jack of the jack assembly;

FIG. 9 is a side view of the jack of FIG. 8 and shown with the first jack moved from a first position (solid line) to an elevated second position (phantom line);

FIG. 10 is a side view of the elevator machine lifting assembly shown positioned adjacent to the stand assembly and with the cart and guide assembly lifted relative to the frame assembly at the second position (FIG. 7) and subsequent to the elevator machine being moved laterally from the cart and onto the motor plate of the stand assembly; and

FIG. 11 is a perspective view of the elevator machine mounted onto the motor plate.

### DETAILED DESCRIPTION

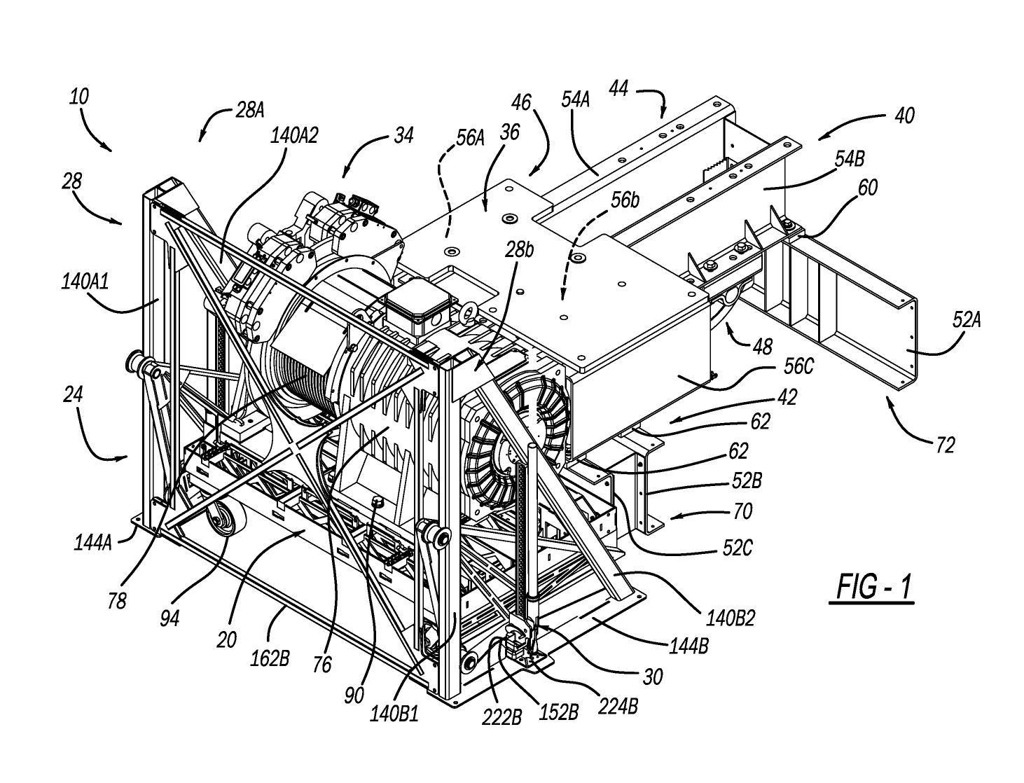

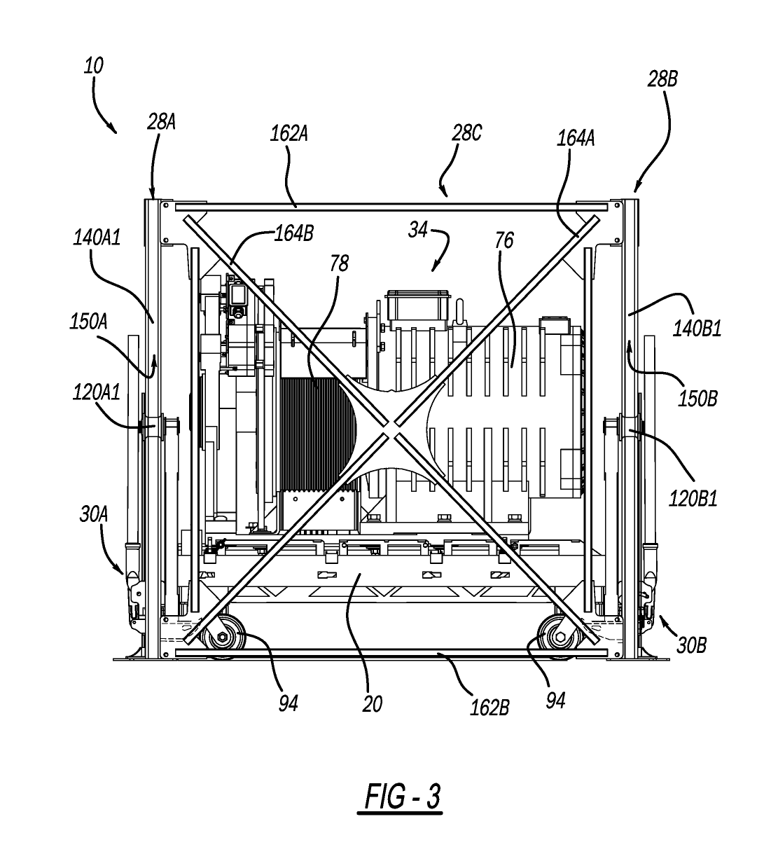

With initial reference to FIGS. 1-4, an elevator machine lifting assembly constructed in accordance to one example of the present teachings is shown and generally identified at reference numeral 10. The elevator machine lifting assembly 10 includes a cart 20, a guide assembly 24, a frame assembly 28 and a jack assembly 30. As will be explained in greater detail below, the elevator machine lifting assembly 10 is configured to lift an elevator machine 34 onto a motor plate 36 of a machine stand assembly 40. The elevator machine lifting assembly 10 can be particularly advantageous when it is required to position an elevator machine 34 onto the motor plate 36 in low overhead applications. In other words, the elevator machine lifting assembly 10 can be used to lift the elevator machine 34 onto the motor plate 36 when an elevator configuration presents low overhead conditions that would complicate or in some cases preclude the elevator machine 34 from being hoisted from above.

The machine stand assembly 40 will be described in greater detail. The machine stand assembly 40 can include a blocking channel assembly 42, a welded channel assembly 44 and a motor channel assembly 46. The welded channel assembly 44 supports a guide sheave 48 and is generally mounted onto the blocking channel assembly 42 in a transverse orientation. In the example shown, the blocking channel assembly 42 includes blocking beams 52A, 52B and 52C. The welded channel assembly 44 includes welded channel beams 54A and 54B. The motor channel assembly 46 includes motor channel beams 56A, 56B and 56C. Isolation pads 60 can be positioned between the welded channel beams 54A, 54B and the blocking beams 52A, 52B and 52C. Isolations pads 62 can also be positioned between the motor channels 56A, 56B and 56C and the blocking beams 52B and 52C. In general, the machine stand assembly 40 defines a car side 70 that aligns with an elevator car (not shown) and a counterweight side 72 that aligns with a counterweight (not shown). While the machine stand assembly 40 has been shown in the drawings and described having particular components, the machine stand assembly 40 is merely exemplary. In this regard, the elevator machine lifting assembly 10 can be configured to work with the machine stand assembly 40 or other machine stand assemblies where it is desirable to lift an elevator machine onto a motor plate.

The elevator machine 34 includes a motor 76 and an elevator drive sheave 78. The motor 76 generates a drive torque on the elevator drive sheave 78. The weight imbalance between the load in the elevator car and the elevator counterweight creates a load torque on the guide sheave 48. Together, the drive torque and the load torque cause the elevator car to rise or descend. It will be appreciated that the elevator machine 34 shown in the drawings and described herein is merely exemplary. In this regard, the elevator machine lifting assembly 10 can be configured to work with the elevator machine 34 or other elevator machines where it is desirable to lift an elevator machine onto a motor plate.

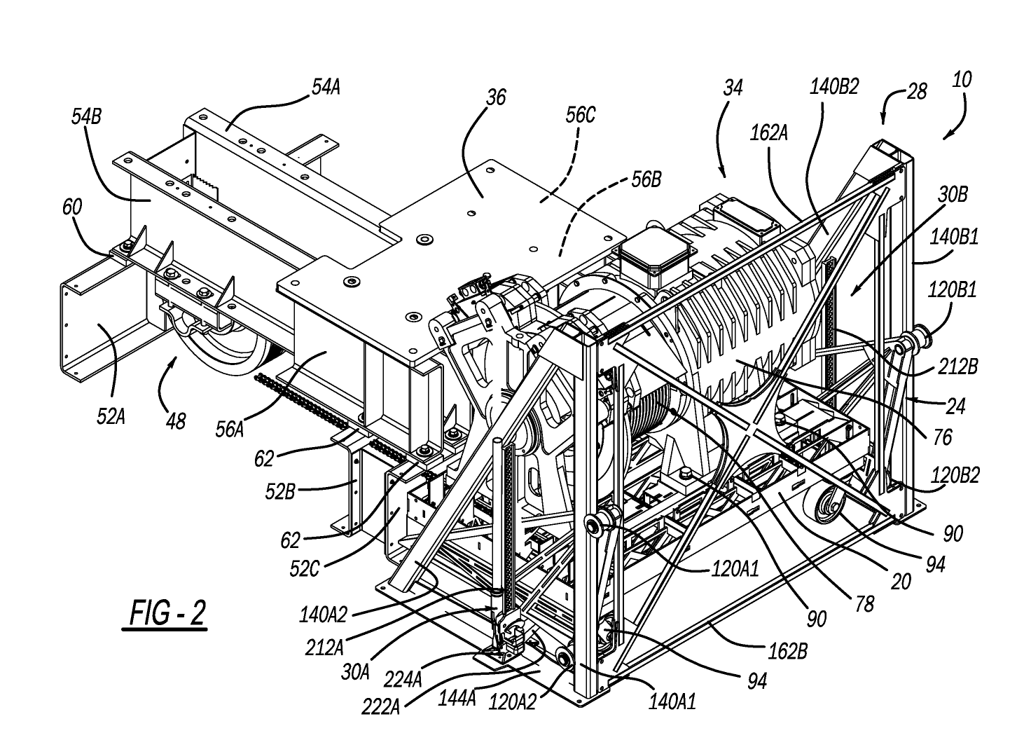

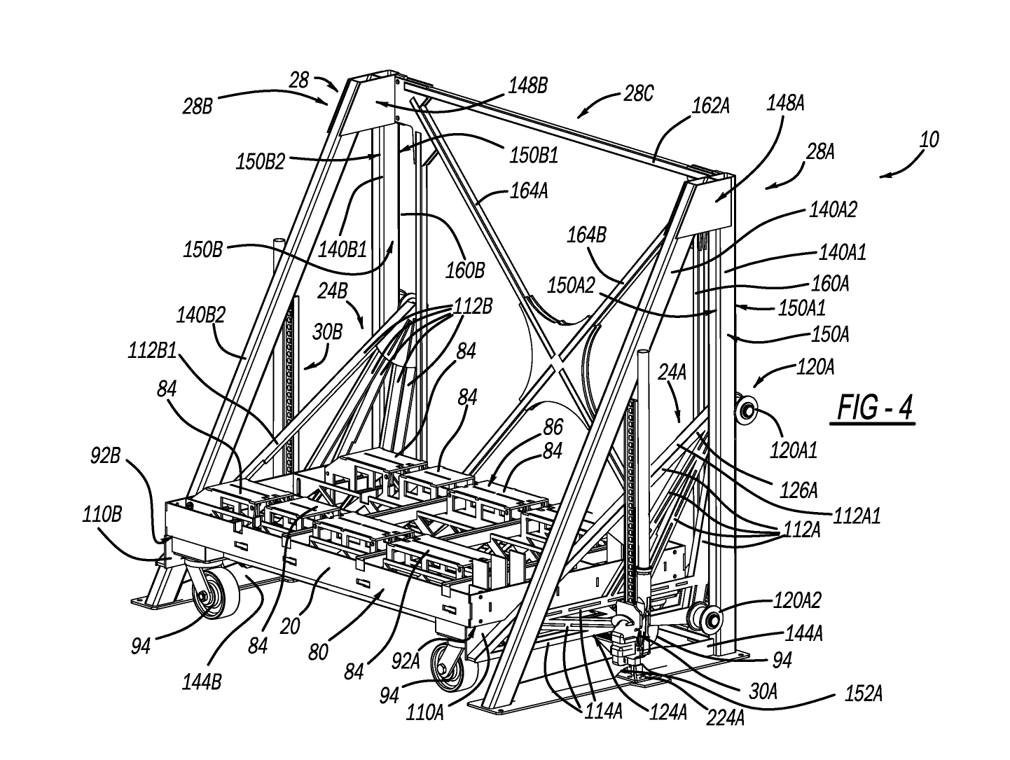

With continued reference to FIGS. 1-3 and particular reference to FIG. 4, the elevator machine lifting assembly 10 will be described in greater detail. The cart 20 includes a cart body 80 that comprises a plurality of rigid protruding platform sections 84 that collectively define a machine mounting platform 86. The elevator machine 34 can be located onto the machine mounting platform 86 and secured thereto using fasteners 90 (FIGS. 1 and 2). In some examples passages may be provided in the machine mounting platform 86 for receiving the fasteners 90. In other examples, the passages can be drilled onsite to accommodate the mounting arrangement of a particular elevator machine 34. The cart 20 includes guide rails 92A, 92B (FIG. 4) on opposite sides for receiving portions of the guide assembly 24 as described below. The cart 20 is supported by a plurality of caster wheels 94. The cart 20 may incorporate other features and geometries within the scope of the present disclosure.

The guide assembly 24 will now be described in greater detail. It will be appreciated that while the guide assembly 24 is described as distinct from the cart 20, in some examples, the guide assembly 24 can also encompass the cart 20. In general, the guide assembly 24 guides vertical movement of the cart 20 relative to the frame assembly 28. The guide assembly 24 collectively includes a first guide assembly 24A and a second guide assembly 24B. The first guide assembly 24A will be described herein with the appreciation that the second guide assembly 24B is similarly constructed and identified with like reference numerals having a “B” suffix. The guide assembly 24A includes a guide base 110A, a series of first support members 112A, a series of second support members 114A and a roller assembly 120A having rollers 120A1 and 120A2. The guide base 110A, with the cart 20 supports the elevator machine 34. The first support members 112A extend between a lower portion 124A of the guide assembly 24A to an upper portion 126A of the guide assembly 24A. In the example shown, the first support members 112A generally converge at the upper portion 126A. The second support members 114A generally interconnect with the first support members 112A at the lower portion 124A. The uppermost support member of the first support members 112A, 112B is identified as a lifted support member 112A1, 112B1 as explained further below.

The frame assembly 28 will now be described in greater detail. In general, the frame assembly 28 supports and guides vertical movement of the guide assembly 24 and cart 20. The frame assembly 28 collectively includes a first frame assembly 28A, a second frame assembly 28B and a connecting frame assembly 28C. The first frame assembly 28A will be described herein with the appreciation that the second frame assembly 28B is similarly constructed and identified with like reference numerals having a “B” suffix. The first frame assembly 28A is shaped generally as an A-frame having first and second vertical support members 140A1 and 140A2 extending from a baseplate 144A and converging at an apex joint 148A. The first vertical support member 140A1 provides a track 150A that supports rolling motion of the first and second rollers 120A1 and 120A2. A notch or recess 152A is defined in the baseplate 144A for securely receiving a portion of the lifting assembly 20 as will be described herein. The connecting frame assembly 28C connects the first and second frame assemblies 28A and 28B. The connecting frame assembly 28C includes a pair of vertical support members 160A, 160B, a pair of lateral support members 162A, 162B and a pair of cross members 164A, 164B.

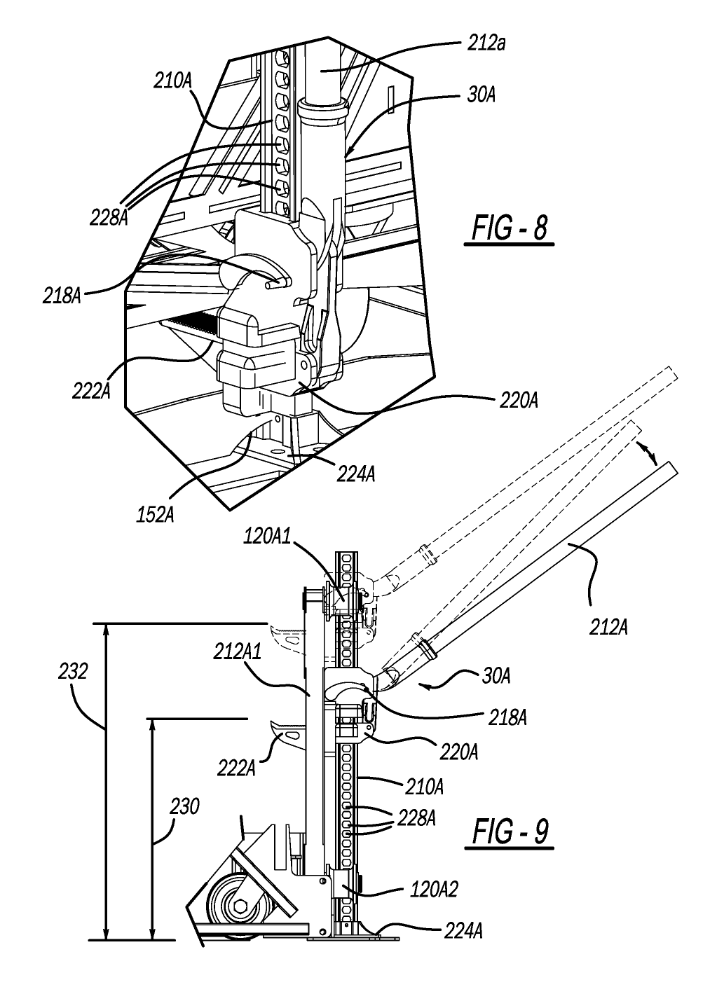

With additional reference now to FIGS. 8 and 9, the jack assembly 30 will be described in greater detail. In general, the jack assembly 30 lifts the guide assembly 24 relative to the frame assembly 28. The guide assembly 24 in turn lifts the cart 20 and the elevator machine 34. The jack assembly 30 collectively includes a first jack assembly 30A and a second jack assembly 30B. The first jack assembly 30A will be described herein with the appreciation that the second jack assembly 30B is similarly constructed and identified with like reference numerals having a “B” suffix. The jack assembly 30A can be a conventional farm jack having a vertical column 210A, a handle 212A, a base plate 216A, a reversing latch 218A, a small runner 220A, a lifting member or large runner 222A and a support plate 224A. Rotational motion of the handle 212A will cause pins to selectively located into and out of adjustment holes 228A defined in the vertical column 210A. With each full motion of the handle 212A the large runner 222A progressively moves upward along the vertical column 210A such as from a first elevation 230 to a second elevation 232. It will be appreciated that the configuration of the jack assembly 30 is merely exemplary and that other jacks or mechanisms can be used to elevate the guide assembly 24 relative to the frame assembly 28.

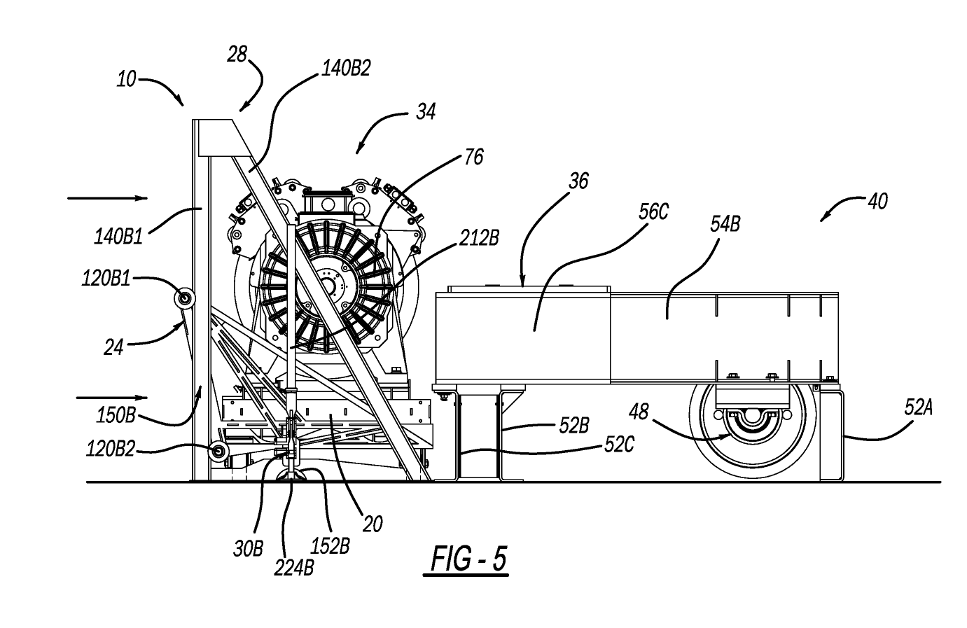

With reference now to all FIGS, an exemplary method for using the elevator machine lifting assembly 10 for lifting the elevator machine 34 will be described. It will be appreciated that additional or fewer steps may be used while still reaching a similar result within the scope of the present disclosure. The elevator machine 34 is initially located onto the cart 20. The elevator machine 34 can be secured to the cart 20 by tightening the fasteners 90 (see FIGS. 1 and 2). Next, the cart 20 with the elevator machine 34 is located adjacent to the machine stand assembly 40 (FIGS. 1, 2 and 5). In one example, the cart 20 can be rolled along the caster wheels 94 to a desired position adjacent to the machine stand assembly 40. The baseplates 110A, 110B (FIG. 4) are aligned and anchored directly under the cart 20. The baseplates 110A, 110B are positioned under the guide rails 92A, 92B of the cart 20 (FIG. 4). Next, the frame assembly 28 is positioned relative to the guide assembly 24. In one example, the vertical guide posts 140A1, 140B1 are installed between the pairs of rollers 120A1, 120A2 (FIG. 4) and 120B1, 120B2 (FIG. 5).

Next it is confirmed that the cart 20, guide assembly 24 and frame assembly 28 have been positioned relative to each other such that the first pair of rollers 120A1, 120A2 will roll along the track 150A and the second pair of rollers 120B1, 120B2 will roll along the track 150B. The jack assembly 30 can now be positioned relative to the frame assembly 28. In the example shown, the support plates 224A, 224B of the first and second jack assemblies 30A, 30B are located at least partially through the notches 152A, 152B in the respective baseplates 144A, 144B (see FIGS. 1, 2 and 4). Once it is confirmed that the large runners 222A, 222B have been located under the lower portions 124A, 124B of the guide assembly 24A, 24B, the guide assembly 24, cart 20 and elevator machine 34 are ready to be lifted relative to the frame member 28 using the jack assembly 30.

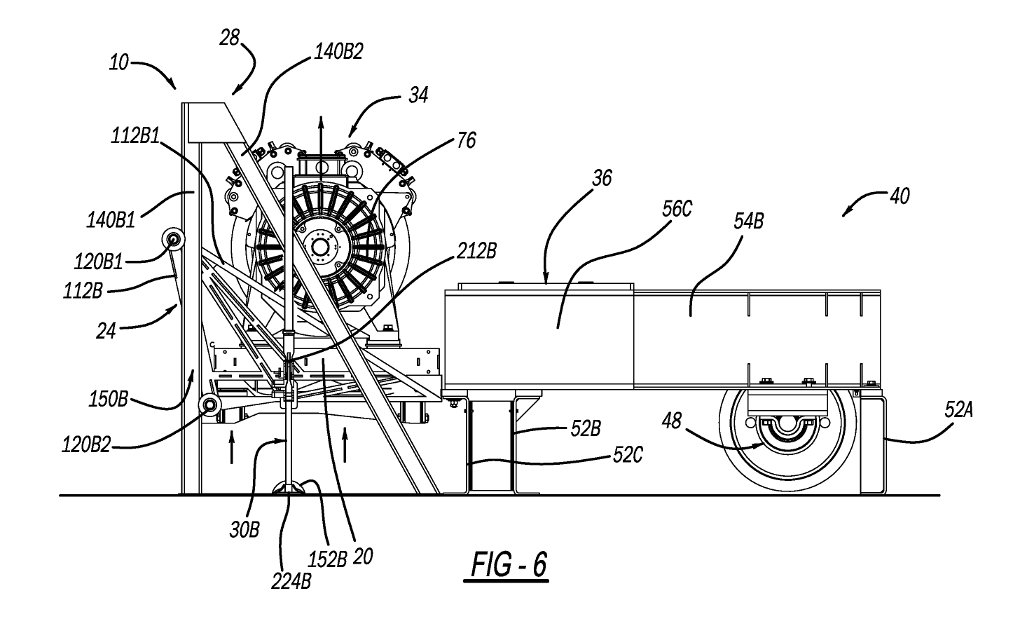

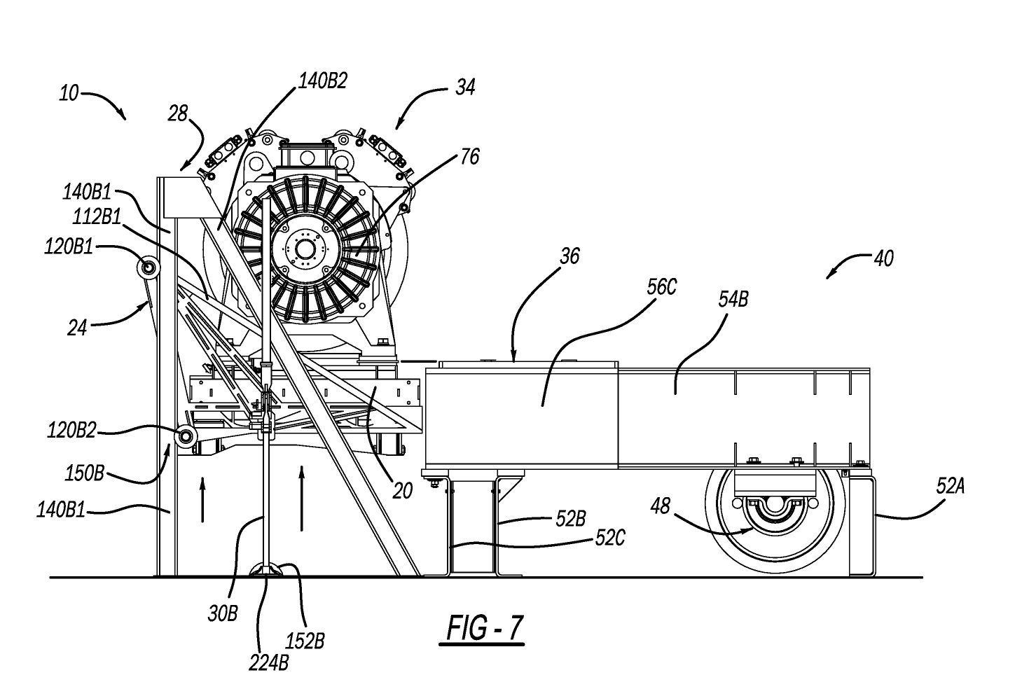

In one example, the first and second jack assemblies 30A, 30B are operated concurrently. Rotation of the jack handles 212A, 212B (FIG. 9) causes the large runners 222A, 222B to progressively move upwardly along the vertical columns 210A, 210B. Actuation of the jack assemblies 30A, 30BB causes the guide assembly 24, cart 20 and elevator machine 34 to move from an initial starting position (FIG. 5) to an intermediate lifted position (FIG. 6) and to a desired final lifted position (FIG. 7). It will be appreciated that during upward movement of the guide assembly 24 relative to the frame assembly 28, the first pair of rollers 120A1, 120A2 roll along the first track 150A (FIG. 4). Specifically, the roller 120A1 rolls along surface 150A1 of the first track 150A while the roller 120A2 rolls along surface 150A2 of the first track 150A. As the surfaces 150A1 and 150A2 are oppositely facing, the configuration provides a sturdy track 150A for the guide assembly 24 to be guided along. Similarly, the second pair of rollers 120B1, 120B2 roll along the second track 150B (FIG. 4). The roller 120B1 rolls along surface 150B1 of the second track 150B while the roller 120B2 rolls along surface 150B2 of the second track 150B.

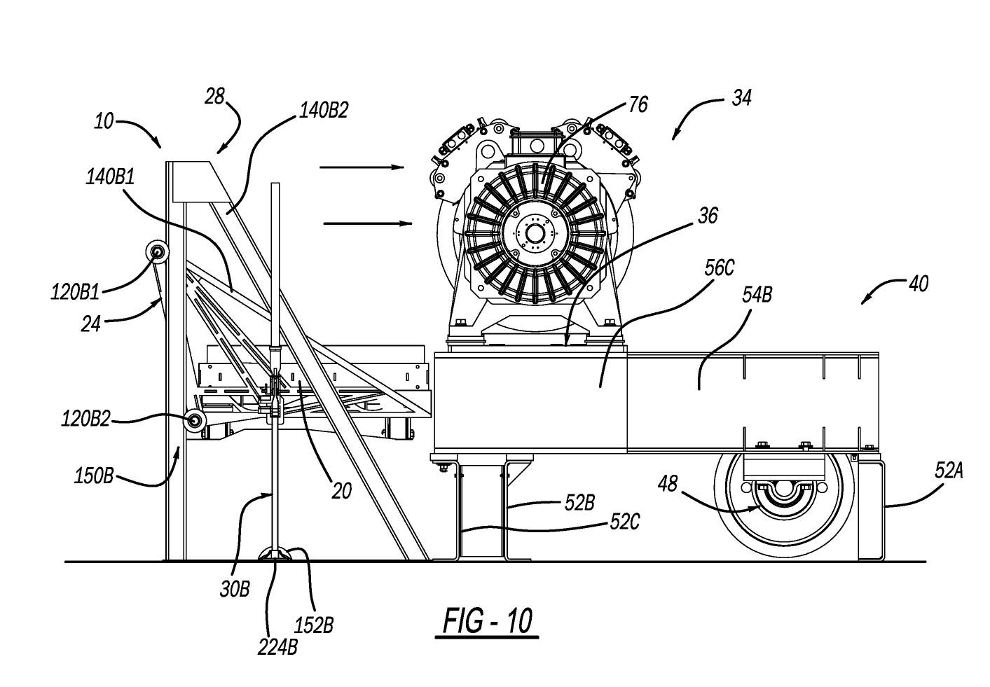

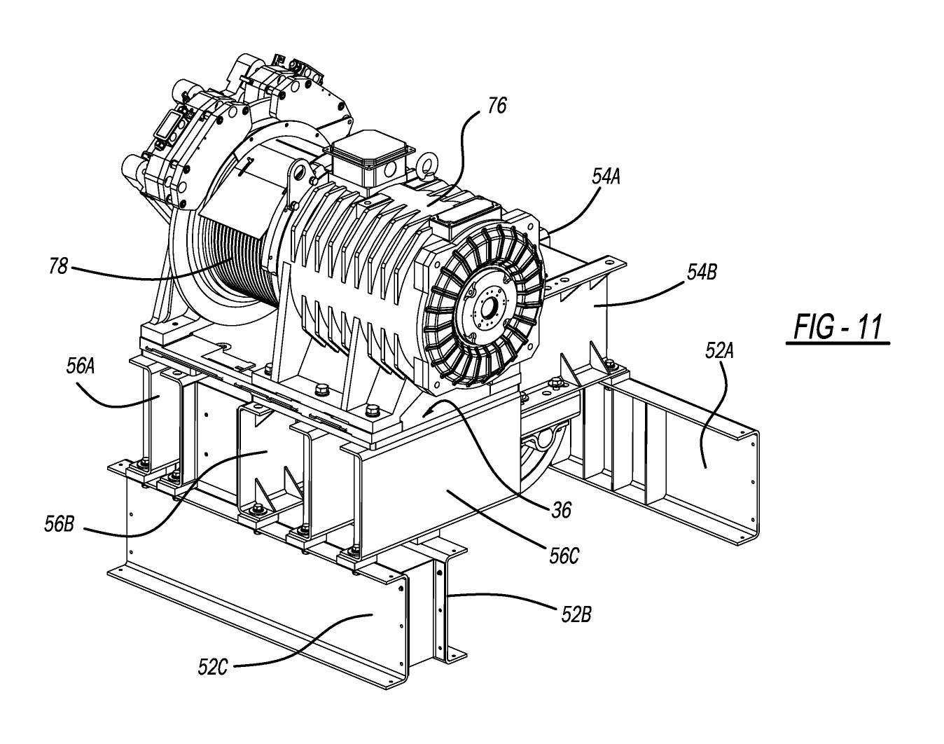

The desired final lifted position is attained generally when the bottom of the elevator machine 34 is parallel to, or on a common plate with, the motor plate 36 of the machine stand assembly 40. Next, the elevator machine 34 is moved laterally from the position shown in FIG. 7 to the position shown in FIG. 10. The elevator machine 34 can be moved by any method such as with a come-a-long tool or other mechanism. The elevator machine 34 can then be secured to the motor plate 36 as shown in FIG. 11.

The elevator machine lifting assembly 10 provides many advantages over existing lifting configurations. For example, the elevator machine lifting assembly 10 eliminates the need for costly overhead support beams. The elevator machine lifting assembly 10 eliminates hoisting concerns associated with low overhead conditions. Use of the elevator machine lifting assembly 10 eliminates the need for multiple chainfalls and rigging tools typically associated with hoisting an elevator machine from above. In addition, risks associated with creative hoisting and rigging from above are minimized. The elevator machine lifting assembly is a temporary structure that can be used as needed and removed subsequent to installation of the elevator machine.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. In this regard, the ordering of method steps is not necessarily fixed, but may be capable of being modified without departing from the instant teachings. Such variations are not to be regarded as a departure from the disclosure, and all such modifications are intended to be included within the scope of the disclosure.

What is claimed is:

1. An elevator machine lifting assembly comprising:
a guide assembly having:
a guide base that supports the elevator machine; and
at least one roller;
a frame assembly having a first vertical support member and a first baseplate wherein the first vertical support member provides a first track that receives the at least one roller thereon; and
a first jack assembly having a first lifting member that selectively moves relative to a first vertical column between a first position and a second position, the second position having a higher elevation than the first position;
wherein movement of the lifting member from the first position to the second position causes the guide base and elevator machine to be raised relative to the frame assembly while the at least one roller rolls along the first track.

2. The elevator machine lifting assembly of claim 1 wherein the at least one roller comprises a first pair of rollers, the first pair of rollers configured to roll along the first track.

3. The elevator machine lifting assembly of claim 2 wherein the rollers of the first pair of rollers roll along opposite surfaces of the first vertical support member.

4. The elevator machine lifting assembly of claim 2 wherein the frame assembly comprises a first frame assembly, a second frame assembly and a connecting frame assembly, the first and second frame assemblies positioned outboard of the elevator machine.

5. The elevator machine lifting assembly of claim 4 wherein the first frame assembly includes the first vertical support member and the first baseplate, the second frame assembly further comprising a second vertical support member and a second baseplate wherein the second vertical support member provides a second track.

6. The elevator machine lifting assembly of claim 5, wherein the guide assembly further comprises a first guide assembly having the first pair of rollers and a second guide assembly having a second pair of rollers.

7. The elevator machine lifting assembly of claim 6 wherein the rollers of the second pair of rollers roll along opposite surfaces of the second vertical support member.

8. The elevator machine lifting assembly of claim 5 wherein the first baseplate defines a notch that receives a portion of the jack assembly.

9. The elevator machine lifting assembly of claim 1, further comprising a cart having a cart body that includes a plurality of rigid protruding platform sections that collectively define a machine mounting platform.

10. The elevator machine lifting assembly of claim 9 wherein the cart includes guide rails that engage the guide base during movement of the lifting member from the first position to the second position.

11. The elevator machine lifting assembly of claim 9 wherein the cart is supported by a plurality of caster wheels.

12. The elevator machine lifting assembly of claim 5, further comprising a second jack assembly having a second lifting member that selectively moves relative to a second vertical column between a first position and a second position, wherein the first and second lifting members locate under the first and second baseplates.

13. A method of lifting an elevator machine from below with an elevator machine lifting assembly and onto a motor plate of a machine stand assembly, the method comprising:
positioning the elevator machine onto a cart of the machine lifting assembly;
locating the cart and elevator machine adjacent to the machine stand assembly;
positioning first and second baseplates of a guide assembly under the cart;
locating first and second vertical guide posts relative to a first and second pair of rollers extending from the guide assembly;
positioning first and second jack assemblies into engagement with the respective first and second baseplates;
actuating the first and second jack assemblies whereby first and second lifting members lift the first and second baseplates and therefore the elevator machine relative to the first and second vertical guide posts.

14. The method of claim 13, further comprising:
rolling the first pair of rollers along the first vertical guide post; and
rolling the second pair of rollers along the second vertical guide post.

15. The method of claim 14 wherein rolling the first pair of rollers includes rolling a first roller along a first surface of the first vertical guide post and rolling a second roller along a second surface of the first vertical guide post, wherein the first and second surfaces are oppositely facing.

16. The method of claim 13 wherein the first and second jack assemblies are actuated concurrently.

17. The method of claim 13 wherein positioning the first and second jack assemblies comprises:
locating a first support plate on the first jack assembly at least partially through a first notch defined in the first baseplate; and
locating a second support plate on the second jack assembly at least partially through a second notch defined in the second baseplate.

18. The method of claim 13 wherein positioning the elevator machine onto the cart further comprises securing the elevator machine to the cart with fasteners.

19. The method of claim 13 wherein locating the cart and elevator machine adjacent to the machine stand assembly comprises:
rolling the cart along wheels extending from the cart.
